(19) United States
(12) Patent Application Publication
(10) Pub. No.: US 2012/0023932 A1
(43) Pub. Date: Feb. 2, 2012

(54) SYSTEM AND METHOD FOR CALCULATING A VEHICLE EXHAUST MANIFOLD PRESSURE

(75) Inventors: Ping Ge, Northville, MI (US); Yue-Yun Wang, Troy, MI (US)

(73) Assignee: GM GLOBAL TECHNOLOGY OPERATIONS, INC., Detroit, MI (US)

(21) Appl. No.: 12/844,869

(22) Filed: Jul. 28, 2010

(51) Int. Cl. F02D 23/00

(52) U.S. Cl. 60/602

(57) ABSTRACT

A vehicle includes an engine, an air intake assembly having a variable geometry turbine (VGT) controllable using a turbine mass flow map, an exhaust manifold, and a controller. The controller calculates a pressure ratio between the inlet and outlet sides of the VGT, and first and second exhaust manifold pressures using respective first and second models. Each of the models extracts information from the map. The controller executes a control action using the first pressure when the ratio exceeds a threshold, using the second pressure otherwise. The controller itself is also disclosed herein, as is a method for controlling an engine operation aboard the vehicle. The method includes using the host machine to calculate the exhaust pressure ratio, to calculate the first and second pressures using the respective first and second models, and to execute a control action using the first or second exhaust pressure depending on the ratio.

### TECHNICAL FIELD

The invention relates to a system and a method for calculating a vehicle exhaust manifold pressure.

### BACKGROUND

In a vehicle having an internal combustion engine, exhaust gas is discharged from each engine cylinder and collected by an exhaust manifold. The exhaust manifold ultimately directs the collected exhaust gas from the engine to the vehicle's exhaust system, where it is typically processed through one or more catalysts and a particulate filter before being discharged as processed exhaust gas to the surrounding atmosphere through a tail pipe. Exhaust manifold pressure is an important feedback value for the regulation of the fuel combustion process, with this value typically measured in the exhaust manifold using a temperature-resistant pressure transducer.

### SUMMARY

Accordingly, an apparatus and a method are disclosed herein for virtually sensing or calculating exhaust manifold pressure aboard a vehicle. Due to the harsh operating conditions present within an exhaust manifold, physical sensors used to directly measure exhaust pressure at that location in the conventional manner may be less than optimal both in cost and functionality. Virtual sensing technology can therefore be used instead of physical pressure sensors for this purpose. However, the robustness of virtual sensing methods can likewise be less than optimal due to the rapidly varying conditions within the exhaust system of a vehicle.

Therefore, a vehicle is provided herein that includes an engine, an air intake assembly, an exhaust manifold, and a controller. The air intake assembly has a variable geometry turbine (VGT) with inlet and outlet sides, with the VGT being controllable using a calibrated turbine mass flow map accessible by the controller. The controller calculates an exhaust pressure ratio between the inlet and outlet sides of the VGT, as well as first and second exhaust manifold pressures. The first and second exhaust manifold pressures are calculated using respective first and second mathematical models, with each of the models extracting information from the turbine mass flow map and calculating the exhaust manifold pressure in different manners. The controller then executes a control action using the first exhaust manifold pressure when the calculated pressure ratio exceeds a calibrated threshold, and using the second exhaust manifold pressure when the ratio does not exceed the threshold.

A controller is also disclosed herein that may be used with the vehicle noted above. The controller includes a host machine and the first and second mathematical models for calculating the exhaust manifold pressure in two different manners. The host machine calculates a pressure ratio between the inlet and outlet sides of the VGT, as well as a first and a second exhaust manifold pressure using the respective first and second mathematical models, and then executes a control action using the first exhaust pressure manifold pressure when the pressure ratio exceeds a calibrated threshold, and using the second exhaust pressure manifold pressure when the ratio does not exceed the threshold.

A method for controlling an engine operation aboard the vehicle noted above includes using the host machine to calculate a pressure ratio between the inlet and outlet side of the VGT, and to calculate a first and a second exhaust manifold pressure using the respective first and second mathematical models, wherein each of the models extracts information from the turbine mass flow map. The method further includes executing a control action via the host machine using the first exhaust manifold pressure when the pressure ratio exceeds a calibrated threshold, and using the second exhaust manifold pressure when the ratio does not exceed the threshold.

The above features and advantages and other features and advantages of the present invention are readily apparent from the following detailed description of the best modes for carrying out the invention when taken in connection with the accompanying drawings.

### BRIEF DESCRIPTION OF THE DRAWINGS

FIG. 1 is a schematic illustration of a vehicle having a controller adapted for calculating an exhaust manifold pressure as disclosed herein;

FIG. 2 is a schematic logic diagram for the controller shown in FIG. 1; and

FIG. 3 is a flow chart describing an algorithm for calculating exhaust manifold pressure aboard the vehicle shown in FIG. 1.

### DESCRIPTION

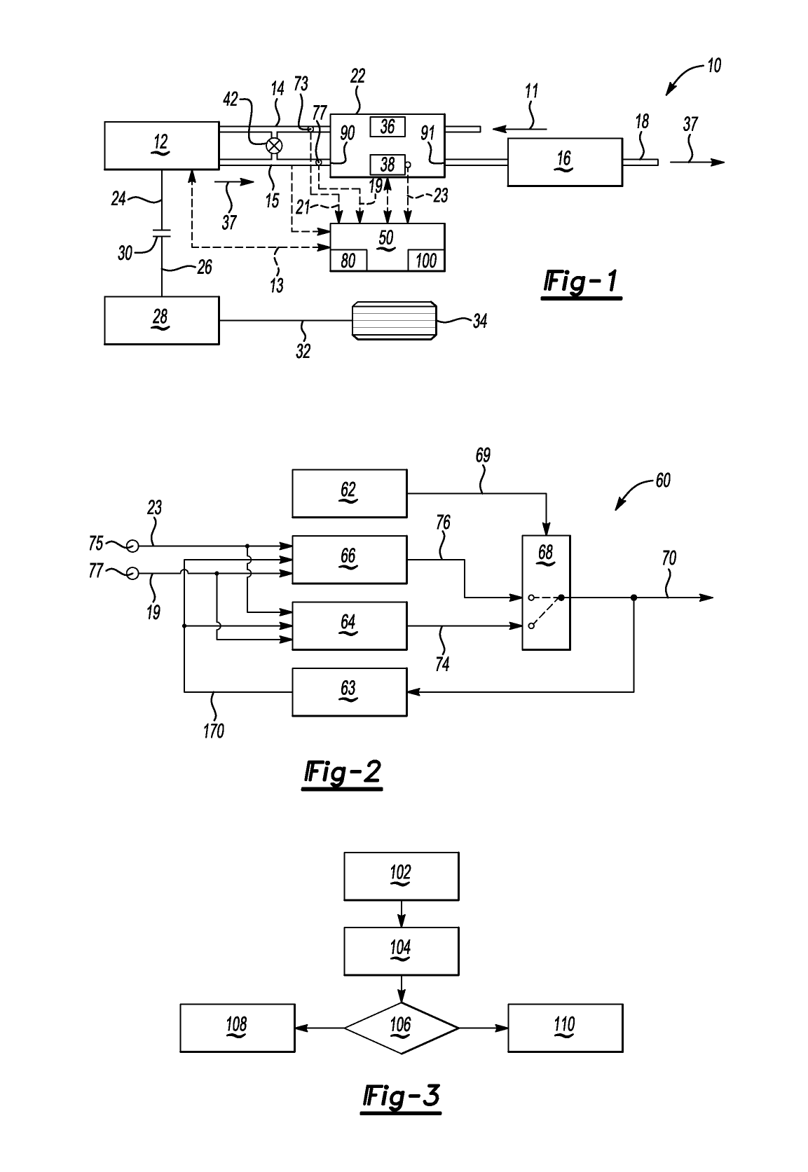

Referring to the drawings, wherein like reference numbers refer to like components, a vehicle 10 is shown in FIG. 1. Vehicle 10 includes an electronic control unit or controller 50 adapted to calculate an exhaust manifold pressure, abbreviated P_{EM} hereinafter, in one of two different manners. That is, the controller 50 selects and executes one of a pair of different mathematical models 64, 66 (see FIG. 2) in order to calculate the exhaust manifold pressure (P_{EM}), as explained in detail below with reference to FIGS. 2 and 3.

The particular model to be used is automatically selected by controller 50 by comparing the value of a calculated exhaust pressure ratio, abbreviated hereinafter as P_{R}, to a calibrated threshold and then selecting one of the models 64 or 66 depending on whether or not the exhaust pressure ration (P_{R}) exceeds the calibrated threshold. The controller 50 can then execute an engine control action, such as regulate an air intake rate aboard the vehicle 10, as needed using the exhaust manifold pressure (P_{EM}) as calculated via the respective selected first or second mathematical model 64, 66.

The vehicle 10 includes an internal combustion engine 12, an intake manifold 14, an exhaust manifold 15, an exhaust system 16, a tail pipe 18, and an air intake assembly 22 having an air compressor 36 and a variable geometry turbine (VGT) 38. Vehicle 10 also includes a plurality of physical sensors, including: a flow sensor 73 positioned at an inlet side of air intake assembly 22, a position sensor 75 sufficiently positioned to measure a vane position of VGT 38, and a temperature model or temperature sensor 77 sufficiently positioned to measure or otherwise determine the outlet temperature of exhaust stream 37 as it passes into the VGT. Flow sensor 73 generates a flow signal 21, the position sensor 75 generates a position signal 23, and temperature sensor 77 generates a temperature signal 19, each of which is relayed to controller 50 for use in calculating the exhaust manifold pressure (P_{EM}) as set forth below.

Engine 12 combusts fuel to generate engine torque, which drives an engine output shaft 24. Output shaft 24 is selectively connectable to an input member 26 of a transmission 28 via a clutch 30. Transmission 28 has an output member 32 which ultimately delivers drive torque from the engine 12, and/or from one or more motor/generator units (not shown) when vehicle 10 is configured as a hybrid electric vehicle, to a set of wheels 34, with only one of the wheels being shown in FIG. 1 for simplicity.

Air, which is represented in FIG. 1 by arrow 11, is drawn into the engine 12 via the air intake assembly 22. Air intake assembly 22 includes the air compressor 36 and VGT 38 noted above, with the VGT being a turbocharger device having an inlet side 90, an outlet side 91, and multiple vanes each with a variable geometry or turbine angle. As understood by those of ordinary skill in the art, a VGT such as the VGT 38 shown in FIG. 1, is a turbocharger turbine which converts the gasses of the exhaust stream 37 into mechanical energy suitable for driving the air compressor 36. VGT 38 regulates the volume and rate of air being fed into engine 12 via its blade or vane position, which may be automatically adjusted by controller 50. This vane position is hereinafter abbreviated as VGT_{POS}, a value which is communicated to controller 50 as the position signal 23.

Still referring to FIG. 1, controller 50 is in communication with the engine 12, an exhaust gas recirculation (EGR) valve 42, and the various components of air intake assembly 22 via a set of control signals 13, some of which are processed by the controller using an algorithm 100 in order to calculate the exhaust manifold pressure (P_{EM}) as set forth below. EGR valve 42 can be controlled as needed to selectively direct a portion of the exhaust stream 37 discharged via the exhaust manifold 15 back into the intake manifold 14 as needed. The remaining exhaust stream 37 passes into the exhaust system 16 where devices such as one or more oxidation catalysts, a particulate filter, a selective reduction catalyst, a muffler, and the like (not shown) further process the exhaust gas before it is ultimately discharged to atmosphere via tailpipe 18.

Controller 50 may be configured as a control module or a host machine programmed with or having access to algorithm 100. Controller 50 is configured to calculate the exhaust manifold pressure (P_{EM}) at or in the exhaust manifold 15 in each of two different manners depending on the value of the exhaust pressure ratio (P_{R}), and to use the calculated exhaust manifold pressure to control an operation of vehicle 10.

Controller 50 may be configured as a digital computer acting as a vehicle controller, and/or as a proportional-integral-derivative (PID) controller device having a microprocessor or central processing unit (CPU), read-only memory (ROM), random access memory (RAM), electrically-erasable programmable read only memory (EEPROM), a high-speed clock, analog-to-digital (A/D) and/or digital-to-analog (D/A) circuitry, and any required input/output circuitry and associated devices, as well as any required signal conditioning and/or signal buffering circuitry. Algorithm 100 and any required reference calibrations are stored within or readily accessed by controller 50 to provide the functions described below with reference to FIGS. 2 and 3.

Referring to FIG. 2, algorithm 100 can be broadly explained with reference to a schematic logic flow diagram 60. Diagram 60 includes a pressure ratio calculation block 62, respective first and second mathematical models 64 and 66, a delay block 63, and a software switch 68. The software switch 68 uses the result of a threshold comparison to determine which of the respective first and second mathematical models 64 or 66 will be used to calculate the exhaust manifold pressure (P_{EM}), which is ultimately used as an output signal 70 for subsequent engine control or air intake regulation.

Pressure ratio calculation block 62 calculates and holds a data value for the exhaust pressure ratio (P_{R}), i.e., the ratio of pressure at the inlet side 90 of the VGT 38 to the pressure at the outlet side 91 of the VGT, or

$$\frac{{P}_{turb\_in}}{{P}_{turb\_out}} ,$$

as calculated by the controller 50 shown in FIG. 1. This function may be performed by first calculating the mass flow (\dot{m}) of the exhaust stream 37 flowing through the VGT 38, and then by solving for the exhaust manifold pressure ratio (P_{R}), e.g., using the following equation:

\dot{m}=k₁\sqrt{1−P_{R}^{k}^{₂}},

where the terms k₁ and k₂ are traces extracted or derived from a calibrated turbine mass flow map 80. As understood by one of ordinary skill in the art, a turbine mass flow map is a set of curves plotting the pressure ratio across the VGT 38 versus turbine mass flow and efficiency, thus describing how turbine performance changes with respect to the pressure drop across the VGT 38. Map 80 is of the type typically provided by a manufacturer of the VGT 38 upon delivery of the VGT. The values k₁ and k₂ are functions of the measured vane position of the VGT 38, a value which is made available to the controller 50 as the position signal 23 as transmitted by position sensor 75 (also see FIG. 1). The exhaust pressure ratio (P_{R}) is then relayed as a signal 69 to the software switch 68. Software switch 68 then determines which of the respective first and second mathematical models 64 and 66 to use in calculating the exhaust manifold pressure (P_{EA}) based on the results of a comparison of the exhaust pressure ratio (P_{R}) to a calibrated threshold.

To determine mass flow (\dot{m}) through the VGT 38, the first mathematical model 38 delays the exhaust manifold pressure (P_{EM}), i.e., the output signal 70, using delay block 63 by applying a suitable lag or time delay. A delayed pressure signal 170 is thus generated. First mathematical model 64 uses as input signals the delayed pressure signal 170, which may be calculated in a previous control loop, the temperature signal 19 measured at the inlet side of VGT 38 by the temperature sensor 77, and the position signal 23 measured by the position sensor 75 as described above. Controller 50 calculates the turbine mass flow (\dot{m}), i.e., the mass flow of the exhaust stream 37 passing through VGT 38, using the following equation:

$$\dot{m} = \frac{\sqrt{{T}_{turb\_inlet}}}{{P}_{EM}} {\dot{m}}_{exh}$$

with the value of the exhaust pressure (P_{EM}) being initially predefined or calibrated, and the mass flow rate of the exhaust gas, i.e., \dot{m}ₑₓₕ, calculated using the data from flow sensor 73, the specific heat of the gasses comprising the exhaust stream 37, etc. Using the pressure ratio (P_{R}) from calculation block 62, the controller 50 can then calculate the exhaust manifold pressure (P_{EM}) as the output signal 70.

The second model 66 calculates exhaust manifold pressure (P_{EM}) in a different manner from that of first model 64, in particular by mathematically inverting the mass flow map 80 for the VGT 38. Second model 66 uses as input signals the turbine inlet temperature signal 19 and the position signal 23. Controller 50 then calculates a transferred turbine mass flow (\dot{m}ₜᵣₐₙ) value as follows:

$${\dot{m}}_{tran} = {P}_{R} {\dot{m}}_{c} = {P}_{R} \frac{\sqrt{{T}_{turb\_inlet}}}{{P}_{EM}} {\dot{m}}_{turb} = \frac{\sqrt{{T}_{turb\_inlet}}}{{P}_{turb\_outlet}} {\dot{m}}_{turb}$$

where the value \dot{m}_{c} is the corrected mass flow rate, which can be determined as a function of the pressure ratio (P_{R}) and VGT vane position (VGT_{POS}), and where \dot{m}_{turb} is taken from the turbine mass flow map 80 after it has been transferred to a new coordinate system. Controller 50 then calculates the exhaust manifold pressure (P_{EM}) in a second manner as:

$${P}_{EM} = {P}_{turb\_outlet} f ( \frac{\sqrt{{T}_{turb\_inlet}}}{{P}_{turb\_outlet}} {\dot{m}}_{turb} , {VGT}_{POS} )$$

Software switch 68 then takes the output signals 74 and 76 from first and second mathematical models 64, 66, respectively, and the pressure ratio signal 69 from calculation block 62, and then compares the exhaust pressure ratio (P_{R}) of signal 69 to a calibrated threshold. If the exhaust pressure ratio (P_{R}) exceeds the calibrated threshold, controller 50 passes the exhaust manifold pressure output value 70 using the value calculated via the first mathematical model 64. Otherwise, the controller 50 passes the exhaust manifold pressure as the output value 70 calculated via the second mathematical model 66.

Referring to FIG. 3, algorithm 100 begins at step 102, wherein the pressure ratio (P_{R}) is calculated and stored in memory. The algorithm 100 then proceeds to step 104, wherein the exhaust pressure (P_{EM}) is calculated via two different approaches, i.e., the first and second mathematical models 64 and 66, respectively, which are explained in detail above.

At step 106, the calculated values are fed forward to the software switch 68 of FIG. 2, and logic is applied in order to determine which of the respective first or second mathematical models 64, 66 to use. In one embodiment, the controller 50 compares the pressure ratio (P_{R}) to a calibrated threshold. The algorithm 100 proceeds to step 108 when the pressure ratio (P_{R}) exceeds the calibrated threshold, and to step 110 when the pressure ratio does not exceed the calibrated threshold.

At steps 108 and 110, the controller 50 feeds forward the exhaust pressure (P_{EM}) from a respective one of the first mathematical model 64 (step 108) and the second mathematical model 66 (step 110), and uses this value in controlling an operation of the engine 12 of FIG. 1, e.g., by regulating the air intake rate. Algorithm 100 may continue in a loop having a suitable period, thereby continuously controlling the operation of engine 12 and the air intake assembly 22.

While the best modes for carrying out the invention have been described in detail, those familiar with the art to which this invention relates will recognize various alternative designs and embodiments for practicing the invention within the scope of the appended claims.

1. A vehicle comprising:
an engine;
an air intake assembly having a variable geometry turbine (VGT) with an inlet side and an outlet side, the VGT having a performance defined by a turbine mass flow map;
an exhaust manifold for receiving exhaust gas from the engine, and having an exhaust manifold pressure; and
a controller adapted for:
calculating a pressure ratio between the inlet and the outlet side of the VGT;
calculating a first and a second exhaust manifold pressure using a first and a second mathematical model, respectively, wherein each of the first and the second mathematical models use information provided from the turbine mass flow map; and
executing a control action using the first exhaust manifold pressure when the pressure ratio exceeds a calibrated threshold, and using the second exhaust manifold pressure when the pressure ratio does not exceed the calibrated threshold.

2. The vehicle of claim 1, wherein the control action includes regulating a function of the air intake assembly.

3. The vehicle of claim 2, wherein the control action includes automatically regulating a vane position of the VGT.

4. The vehicle of claim 1, wherein the intake assembly includes an exhaust gas recirculation (EGR) valve, and wherein the controller is configured to regulate an operation of the EGR valve.

5. The vehicle of claim 1, further comprising a first sensor positioned with respect to the air intake assembly and adapted to measure a flow rate of the exhaust stream through the VGT, a second sensor which measures the vane position of the VGT, and a third sensor which measures an inlet temperature to the VGT, wherein each of the sensors is in communication with the controller, and wherein the controller uses the flow rate, the vane position, and the inlet temperature to calculate the exhaust manifold pressure in each of the first and the second mathematical models.

6. The vehicle of claim 5, wherein the controller calculates the mass flow of the exhaust stream using the flow rate, then solves for the pressure ratio as function of the mass flow and values from the turbine mass flow map.

7. The vehicle of claim 5, wherein the first model includes a function of the mass flow rate of the exhaust gas and the turbine inlet temperature from the temperature sensors, and the second mathematical model mathematically inverts the mass flow map and transfers the turbine mass flow map to a coordinate system different from that of the turbine mass flow map prior to the transfer.

8. A controller for use with a vehicle having an engine, an air intake assembly having a variable geometry turbine (VGT) with an inlet side and an outlet side, and an exhaust manifold for receiving exhaust gas from the engine, the controller comprising:
a first mathematical model and a second mathematical model for calculating an exhaust manifold pressure using different equations; and
a host machine operable for:
calculating a pressure ratio between the inlet and outlet sides of the VGT;
calculating a first and a second exhaust manifold pressure using the first and the second mathematical model, respectively; and
executing a control action using the first exhaust manifold pressure when the ratio exceeds a calibrated threshold, and using the second exhaust manifold pressure when the ratio does not exceed the calibrated threshold.

9. The controller of claim 8, wherein the control action includes regulating a function of the air intake assembly.

10. The controller of claim 9, wherein the control action includes automatically regulating a vane position of the VGT.

11. The controller of claim 8, further comprising a first sensor adapted to measure a flow rate of the exhaust stream into the VGT, a second sensor which measures the vane position of the VGT, and a third sensor which measures an inlet temperature to the VGT, wherein each of the sensors is in communication with the controller, and wherein the controller uses the flow rate, the vane position, and the inlet temperature to calculate the exhaust manifold pressure in each of the first and the second mathematical models.

12. The controller of claim 11, wherein the controller calculates the mass flow of the exhaust stream using the flow rate, then solves for the pressure ratio as function of the mass flow of the exhaust stream and values provided from the turbine mass flow map.

13. The controller of claim 11, wherein the first mathematical model includes a function of the mass flow rate of the exhaust stream into the VGT and the turbine inlet temperature from the temperature sensor, and the second mathematical model mathematically inverts the turbine mass flow map and transfers the turbine mass flow map after it is inverted to a coordinate system which is different from that of the turbine mass flow map prior to the transfer.

14. A method for controlling an engine operation aboard a vehicle having an engine, an air intake assembly having a variable geometry turbine (VGT) with an inlet side and an outlet side, the VGT being controllable using a turbine mass flow map, an exhaust manifold for receiving exhaust gas from the engine, and a host machine, the method comprising:
using a host machine to calculate a pressure ratio between the inlet and outlet side of the VGT;
using the host machine to calculate a first and a second exhaust manifold using a first and a second mathematical model, respectively, and wherein each of the first and the second mathematical model uses information from the turbine mass flow map; and
executing a control action via the host machine using the first exhaust manifold pressure when the pressure ratio exceeds a calibrated threshold, and using the second exhaust manifold pressure when the pressure ratio does not exceed the calibrated threshold.

15. The method of claim 14, further comprising regulating a vane position of the VGT as the control action.

16. The method of claim 14, the vehicle including a first sensor adapted to measure a flow rate of the exhaust stream into the VGT, a second sensor which measures the vane position of the VGT, and a third sensor which measures an inlet temperature to the VGT, wherein each of the sensors is in communication with the controller, the method further comprising:
using the flow rate, the vane position, and the inlet temperature to calculate the exhaust manifold pressure in each of the first and the second mathematical models.

17. The method of claim 16, further comprising:
calculating the mass flow of the exhaust stream using the flow rate; and
solving for the pressure ratio as function of the mass flow and values from the turbine mass flow map.

18. The method of claim 16, wherein the first mathematical model includes a function of the mass flow rate of the exhaust stream into the VGT and the turbine inlet temperature, and the second mathematical model mathematically inverts the turbine mass flow map and transfers the turbine mass flow map once inverted to a coordinate system that is different from that of the turbine mass flow map prior to the transfer.
